(19) United States
(12) Patent Application Publication
(10) Pub. No.: US 2013/0083856 A1
(43) Pub. Date: Apr. 4, 2013

(54) CONTEXTS FOR COEFFICIENT LEVEL CODING IN VIDEO COMPRESSION

(71) Applicants: Joel Sole Rojals, La Jolla, CA (US); Rajan Laxman Joshi, San Diego, CA (US); Marta Karczewicz, San Diego, CA (US)

(72) Inventors: Joel Sole Rojals, La Jolla, CA (US); Rajan Laxman Joshi, San Diego, CA (US); Marta Karczewicz, San Diego, CA (US)

(73) Assignee: QUALCOMM INCORPORATED, San Diego, CA (US)

(21) Appl. No.: 13/535,975

(22) Filed: Jun. 28, 2012

Related U.S. Application Data
(60) Provisional application No. 61/502,737, filed on Jun. 29, 2011.
(60) Provisional application No. 61/540,924, filed on Sep. 29, 2011.

(51) Int. Cl. H04N 7/26

(52) U.S. Cl. CPC H04N 19/00951
USPC 375/240.18

(57) ABSTRACT

This disclosure describes techniques for coding video data. In particular, this disclosure describes techniques for entropy coding of residual transform coefficients generated by a video coding process. In one example, a method selects a bin 2 context for coding a bin 2 level of one or more transform coefficients in the vector according to the entropy coding process. The method further codes the bin 2 level of one or more transform coefficients in the vector according to the selected bin 2 context. Selecting the bin 2 context comprises selecting the bin 2 context for a current transform coefficient in the vector based on the bin 2 level of one or more previously coded transform coefficients in the vector.

This application claims the benefit of U.S. Provisional Application No. 61/502,737, filed Jun. 29, 2011 and U.S. Provisional Application No. 61/540,924, filed Sep. 29, 2011, each of which is hereby incorporated by reference in its entirety.

### TECHNICAL FIELD

This disclosure relates to video coding, and more particularly to techniques for performing entropy coding in a video coding process.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards, to transmit, receive and store digital video information more efficiently.

Video compression techniques include spatial prediction and/or temporal prediction to reduce or remove redundancy inherent in video sequences. For block-based video coding, a video frame or slice may be partitioned into blocks. Each block can be further partitioned. Blocks in an intra-coded (I) frame or slice are encoded using spatial prediction with respect to reference samples in neighboring blocks in the same frame or slice. Blocks in an inter-coded (P or B) frame or slice may use spatial prediction with respect to reference samples in neighboring blocks in the same frame or slice or temporal prediction with respect to reference samples in other reference frames. Spatial or temporal prediction results in a predictive block for a block to be coded. Residual data represents pixel differences between the original block to be coded and the predictive block.

An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in a particular order to produce a one-dimensional vector of transform coefficients for entropy coding.

### SUMMARY

In general, this disclosure describes techniques for coding video data. In particular, this disclosure describes techniques for entropy coding of residual transform coefficients generated by a video coding process.

In one example of the disclosure, a method of coding transform coefficients in a video coding process comprises scanning transform coefficients into a vector according to a scan order, selecting a bin 1 context for coding a bin 1 level of each transform coefficient in the vector according to an entropy coding process, coding the bin 1 level of each transform coefficient in the vector according to the selected bin 1 context, selecting a bin 2 context for coding a bin 2 level of each transform coefficient in the vector according to the entropy coding process, and coding the bin 2 level of each transform coefficient in the vector according to the selected bin 2 context, wherein selecting the bin 2 context comprises selecting the bin 2 context for a current transform coefficient in the vector based on the bin 2 level of one or more previously coded transform coefficients in the vector.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating inverse scan orders for significance map and coefficient level coding.

FIG. 2 is a conceptual diagram illustrating example context selection in a context adaptive binary arithmetic coding process.

FIG. 3 is a conceptual diagram illustrating an example scanning order for coefficient level coding.

FIG. 4 is a block diagram illustrating an example video encoding and decoding system.

FIG. 5 is a block diagram illustrating an example video encoder.

FIG. 6 is a block diagram illustrating an example video decoder.

FIG. 7 is a flow diagram illustrating and example method in accordance with the systems and methods described herein.

FIG. 8 is a flow diagram illustrating and example method in accordance with the systems and methods described herein.

### DETAILED DESCRIPTION

In general, this disclosure describes techniques for coding video data. In particular, this disclosure describes techniques for entropy coding of residual transform coefficients generated by a video coding process.

Digital video devices implement video compression techniques to transmit and receive digital video information more efficiently. Video compression may apply spatial (intra-frame) prediction and/or temporal (inter-frame) prediction techniques to reduce or remove redundancy inherent in video sequences.

There is a new video coding standard, namely High-Efficiency Video Coding (HEVC), being developed by the Joint Collaboration Team on Video Coding (JCT-VC) of ITU-T Video Coding Experts Group (VCEG) and ISO/IEC Motion Picture Experts Group (MPEG). A recent draft of the HEVC standard, referred to as “HEVC Working Draft 6” or “WD6,” is described in document JCTVC-H1003, Bross et al., “High efficiency video coding (HEVC) text specification draft 6,” Joint Collaborative Team on Video Coding (JCT-VC) of ITU-T SG16 WP3 and ISO/IEC JTC1/SC29/WG11, 8th Meeting: San Jose, Calif., USA, February, 2012, which, as of Jun. 1, 2012, is downloadable from http://phenix.int-evry.fr/jct/doc_end_user/documents/8_San %20Jose/wg11/JCTVC-H1003-v22.zip.

For video coding according to the high efficiency video coding (HEVC) standard currently under development, a video frame may be partitioned into coding units, prediction units and transform units. A coding unit (CU) generally refers to an image region that serves as a basic unit to which various coding tools are applied for video compression. A coding unit is typically rectangular, and may be considered to be similar to a so-called macroblock, e.g., under other video coding standards such as ITU-T H.264.

To achieve better coding efficiency, a coding unit may have variable sizes depending on video content. In addition, a coding unit may be split into smaller blocks for prediction or transform. In particular, each coding unit may be further partitioned into prediction units and transform units. Prediction units may be considered to be similar to so-called partitions under other video coding standards, such as H.264. Transform units refer to blocks of residual data to which a transform is applied to produce transform coefficients.

A coding unit usually has one luminance component, denoted as Y, and two chroma components, denoted as U and V. Depending on the video sampling format, the size of the U and V components, in terms of number of samples, may be the same as or different from the size of the Y component.

To code a block (e.g., a prediction unit of video data), a predictor for the block is first derived. The predictor can be derived either through intra (I) prediction (i.e. spatial prediction) or inter (P or B) prediction (i.e., temporal prediction). Hence, some prediction units may be intra-coded (I) using spatial prediction with respect to neighbouring reference blocks in the same frame, and other prediction units may be inter-coded (P or B) with respect to reference blocks in other frames.

Upon identification of a predictor, the difference between the original video data block and its predictor is calculated. This difference is also called the prediction residual, and refers to the pixel differences between the block to the coded and the reference block, i.e., predictor. To achieve better compression, the prediction residual is generally transformed, e.g., using a discrete cosine transform (DCT), integer transform, Karhunen-Loeve (K-L) transform, or other transform.

The transform converts pixel difference values in the spatial domain to transform coefficients in the transform domain, e.g., a frequency domain. The transform coefficients are normally arranged in a two-dimensional (2-D) array for each transform unit. For further compression, the transform coefficients may be quantized. An entropy coder then applies entropy coding, such as Context Adaptive Variable Length Coding (CAVLC), Context Adaptive Binary Arithmetic Coding (CABAC), context adaptive probability interval partitioning entropy (PIPE) coding with variable length codewords (V2V), or the like, to the quantized transform coefficients.

In general, coding data symbols using CABAC involves one or more of the following steps:

(1) Binarization: If a symbol to be coded is non-binary valued, it is mapped to a sequence of so-called “bins.” Each bin can have a value of “0” or “1.”

(2) Context Assignment: Each bin (in regular mode) is assigned to a context. A context model determines how a context for a given bin is calculated based on information available for the bin, such as values of previously encoded symbols or bin number.

(3) Bin encoding: Bins are encoded with an arithmetic encoder. To encode a bin, the arithmetic encoder requires as an input a probability of the bin's value, i.e., a probability that the bin's value is equal to “0,” and a probability that the bin's value is equal to “1.” The (estimated) probability of each context is represented by an integer value called a “context state.” Each context has a state, and thus the state (i.e., estimated probability) is the same for bins assigned to one context, and differs between contexts.

(4) State update: The probability (state) for a selected context is updated based on the actual coded value of the bin (e.g., if the bin value was “1,” the probability of “1's” is increased).

It should be noted that probability interval partitioning entropy coding (PIPE) uses principles similar to those of arithmetic coding, and can thus also utilize the techniques of this disclosure.

CABAC in H.264/AVC and HEVC uses states, and each state is implicitly related to a probability. There are variants of CABAC, in which a probability of a symbol (“0” or “1”) is used directly, i.e., the probability (or an integer version of it) is the state. For example, such variants of CABAC are described in “Description of video coding technology proposal by France Telecom, NTT, NTT DOCOMO, Panasonic and Technicolor,” JCTVC-A114, 1^{st} JCT-VC Meeting, Dresden, DE, April 2010, referred to as “JCTVC-A114” hereinafter, and A. Alshin and E. Alshina, “Multi-parameter probability update for CABAC,” JCTVC-F254, 6^{th} JCT-VC Meeting, Torino, IT, July 2011, referred to as “JCTVC-F254” hereinafter.

To entropy code a block of quantized transform coefficients, a scanning process is usually performed so that the two-dimensional (2D) array of quantized transform coefficients in a block is processed, according to a particular scan order, in an ordered, one-dimensional (1D) array, i.e., vector, of transform coefficients. Entropy coding is applied in the 1-D order of transform coefficients. The scan of the quantized transform coefficients in a transform unit serializes the 2D array of transform coefficients for the entropy coder. A significance map may be generated to indicate the positions of significant (i.e., non-zero) coefficients. Scanning may be applied to scan levels of significant (i.e., nonzero) coefficients, and/or to code signs of the significant coefficients.

For a DCT, as an example, there is often a higher probability of non-zero coefficients toward an upper left corner (i.e., a low frequency region) of the 2D transform unit. It may be desirable to scan the coefficients in a way that increases the probability of grouping non-zero coefficients together at one end of the serialized run of coefficients, permitting zero-valued coefficients to be grouped together toward another end of the serialized vector and more efficiently coded as runs of zeros. For this reason, scan order may be important for efficient entropy coding.

As one example, the so-called diagonal (or wavefront) scan order has been adopted for use in scanning quantized transform coefficients in the HEVC standard. Alternatively, zig-zag, horizontal, vertical or other scan orders may be used. Through transform and quantization, as mentioned above, non-zero transform coefficients are generally located at the low frequency area toward the upper left region of the block for an example in which the transform is a DCT. As a result, after the diagonal scanning process, which may traverse the upper left region first, non-zero transform coefficients are usually more likely to be located in the front portion of the scan. For a diagonal scanning process that traverses from the lower right region first, the non-zero transform coefficients are usually more likely to be located in the back portion of the scan.

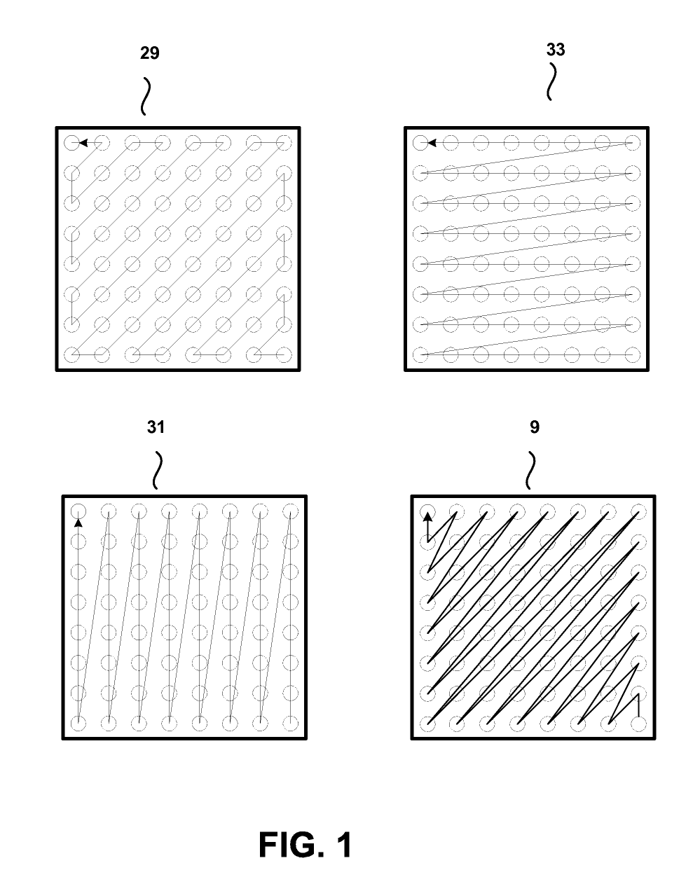

FIG. 1 shows examples of inverse scan orders for a block of transform coefficients, i.e., a transform block. The transform block may be formed using a transform such as, for example, a discrete cosine transform (DCT). Note that each of the inverse diagonal pattern 9, inverse zig-zag pattern 29, the inverse vertical pattern 31, and the inverse horizontal pattern 33 proceed from the higher frequency coefficients in the lower right corner of the transform block to lower frequency coefficients in the upper left corner of the transform block.

In H.264 and the emerging HEVC standard, when the CABAC entropy coder is used, the positions of the significant coefficients (i.e., nonzero transform coefficients) in the block are encoded prior to the levels of the coefficients. The process of coding the locations of the significant coefficients is called significance map coding. The significance map is a map of one's and zero's, where the one's indicate locations of significant coefficients. The significance map typically requires a high percentage of the video bit-rate.

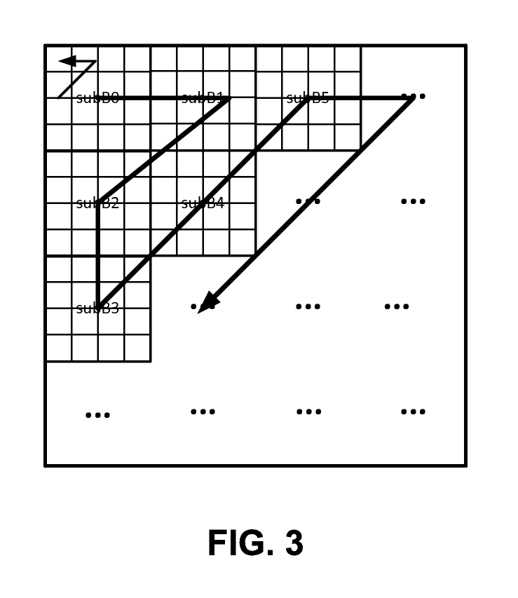

After the significance map is encoded, the level information (the absolute level and sign) for each transform coefficient (i.e., the coefficient value) is encoded. In one example, the coding process for absolute transform coefficient levels includes mapping each quadratic (or rectangular) block of size 8×8 and larger onto an ordered set (e.g., a vector) of 4×4 sub-blocks by using a forward zig-zag scan; while the transform coefficient levels inside a sub-block are processed in a reverse zig-zag scan. FIG. 3 shows an example of a scanning order followed to encode the level information (i.e., absolute values) of transform coefficients. In other examples, the transform coefficients level information inside the sub-blocks are processed using other scan patterns, such as horizontal, vertical, or diagonal scans. Some systems, such as HEVC might use the same scan for the significance map and for level coding. The scan might be a 4×4 sub-block diagonal scan, and a diagonal scan across sub-blocks. When a horizontal and vertical scan is used, some examples may use level coding that also follows a horizontal and vertical scan.

In other examples of scanning level information of transform coefficients, rather than scanning within 8×8 or larger sub-blocks of coefficients, the coefficients are scanned using an inverse scan over a sub-set of the coefficients along the scan order. As one example, a first sub-set could be the first 16 coefficients in the transform unit that are along an inverse diagonal scan order. As such, the coefficients scanned in this process are not necessarily within rectangular sub-blocks. This allows for more coding efficiency as sub-sets of coefficients along the chosen scan order are potentially more correlated.

In the CABAC process previously specified in the H.264 standard, following the handling of 4×4 sub-blocks, each of the transform coefficient levels is binarized, e.g., according to a unary code, to produce a series of bins. In one example, a truncated unary concatenated code with an exponential-Golomb code of 0th order might be used. The CABAC context model set for each sub-block consists of two times six context models with five models for both the first bin and all remaining bins (up to and including the 14^{th} bin) of the coeff_abs_level_minus_one syntax element, which encodes the absolute value of a transform coefficient. In the current proposal for HEVC, the selection of context models is performed similarly as in the original CABAC process proposed for the H.264 standard. However, different sets of context models may be selected for different sub-blocks. In particular, the choice of the context model set for a given sub-block depends on certain statistics of one or more previously coded sub-blocks. In one current proposal for HEVC, CABAC is used for bin 1 and bin2, while the remaining bins use a Rice-Golomb concatenated code with an exponential-Golomb code in bypass mode.

This approach uses 60 contexts: 6 sets of 10 contexts distributed as shown below in tables 1 and 2. For a 4×4 block, 10 models might be used; 5 models for bin 1 and 5 models for bins 2 to 14. Note that in some embodiments of CABAC for HEVC, there are 5 models for bin 1, 5 models for bin 2, and the remaining bins (e.g., bins 3 to 14) use a constant probability model as they are coded in “bypass” mode.

TABLE 1
Contexts for bin 1 and bin 2 of the coefficient levels of sub-block

| Model bin 1 | | Model bin 2 | |
|---|---|---|---|
| 0 | Encoded a larger | 0 | Initial - no larger |
| | than 1 (i.e., at least one | | than one (i.e., no bin 1 |
| | bin 1 value coded as 1) | | value coded as 1) |
| 1 | Initial - no trailing | 1 | 1 larger than one |
| | ones (i.e., no previous | | (i.e., one bin 1 value coded |
| | significant coefficients) | | as 1) |
| 2 | 1 trailing one (i.e., | 2 | 2 larger than one |
| | one previous significant | | (i.e., two bin 1 values coded |
| | coefficient) | | as 1) |
| 3 | 2 trailing ones | 3 | 3 larger than one |
| | (i.e., two previous | | (i.e., three bin 1 values |
| | significant coefficients) | | coded as 1) |
| 4 | 3 or more trailing | 4 | 4 or more larger |
| | ones (i.e., three previous | | than one (i.e., four bin 1 |
| | significant coefficients) | | values coded as 1) |

There are 6 different sets of these 10 models, depending on the number of coefficients larger than 1 in the previous 4×4 sub-block. Table 2 shows the selection criteria for each context set.

TABLE 2
Contexts for bin 1 and bins 2 to 14 depending on the block size and the
values in the number of coefficients larger than one in the previous
sub-block
Context Set

| | |
|---|---|
| 0 | For block size 4×4 only |
| 1 | 0-3 Coefficients Larger than 1 |
| | in previous sub-block |
| | (i.e., up to three previous |
| | significant coefficients) |
| 2 | 4-7 LargerT1 in previous sub- |
| | block |
| | (i.e., 4-7 previous significant |
| | coefficients) |
| 3 | 8-11 LargerT1 in previous sub- |
| | block |
| | (i.e., 8-11 significant |
| | coefficients) |
| 4 | 12-15 LargerT1 in previous |
| | sub-block |
| | (i.e., 12-15 previous significant |
| | coefficients) |
| | First 4×4 sub-block |
| 5 | 16 LargerT1 in previous sub-block |
| | (i.e., sixteen or more previous |
| | significant coefficients) |

In drafts of HEVC, the contexts for coding of bin 2 of the coefficient level are selected based on the bin 1 value of the previously coded coefficients (Table 1), but not on the bin 2 value of any previously coded coefficients. This is unlike the contexts for bin 1, which are selected based on previously coded coefficients in bin 1. That is, the context used for a particular coefficient for bin 1 depends on the number of trailing “ones” previously coded in bin 1. The selection criteria for bin 2 contexts does not make use of all the relevant data available (i.e., previously coded bin 2 values), but rather just relies on the number of previously coded coefficients that are larger than 1. As this information is known from the bin 1 coding, the selection of bin 2 contexts does not use any information from bin 2 coding. As such, the selection criteria for the derivation of bin 2 contexts potentially results in non-optimal performance when performing CABAC with that selection criteria.

This disclosure describes several different features that may reduce or eliminate some of the drawbacks described above. In general, this disclosure proposes deriving bin 2 contexts based on the coded level of previously coded coefficients in the bin 2 scan. While this disclosure is described in terms of a CABAC process, the techniques of the disclosure are applicable for any entropy coding process that utilizes context models.

In one example of the disclosure, the derivation of contexts can be done in a similar fashion as for bin 1 shown in Table 1 above, but counting the number of trailing “2's” rather than “1's”. Table 3 shows this example. The number of previously encoded bins 2 coefficients with a value of 2 is used to select the context to apply for the current coefficient in the bin 2 scan. Context 1 is used for the initial coefficient in the bin 2 scan that has a value of 2. Context 2 is used for any coefficient for which only one previously coded coefficient was coded as having a value of 2 in the bin 2 scan. Context 3 is used for any coefficient for which only two previously coded coefficients were coded as having a value of 2 in the bin 2 scan. Context 4 is used for any coefficient for which three or more previously coded coefficients were coded as having a value of 2 in the bin 2 scan. Context 0 is used for all subsequent coefficients once a coefficient with a value larger than 2 is coded in the bin 2 scan.

TABLE 3
Proposed contexts for bin 2 of the coefficient levels
Model bin 2

| | |
|---|---|
| 0 | Encoded a larger |
| | than 2 |
| | (i.e. at least one bin 2 |
| | value coded as 2) |
| 1 | Initial - no |
| | trailing ‘2’ |
| | (i.e. no previous bin 2 |
| | value coded as 2) |
| 2 | 1 trailing ‘2’ |
| | (i.e. one bin 2 value |
| | coded as 2) |
| 3 | 2 trailing ‘2’ |
| | (i.e. two bin 2 value |
| | coded as 2) |
| 4 | 3 or more trailing |
| | ‘2’ |
| | (i.e. at least three bin 2 |
| | value coded as 2) |

Table 4 shows an alternative embodiment for the bin 2 context model having only 4 contexts.

TABLE 4
Alternative contexts for bin 2 of the coefficient levels
Model bin 2

| | |
|---|---|
| 0 | Encoded a larger than 2 |
| 1 | Initial - no trailing ‘2’ |
| 2 | 1 trailing ‘2’ |
| 3 | 2 or more trailing ‘2’ |

Tables 3 and 4 are example embodiments of the selection criteria for contexts in bin 2. Other selection criteria may be used that utilize the coded value of previous bin 2 coefficients to select the context for the current bin 2 coefficient.

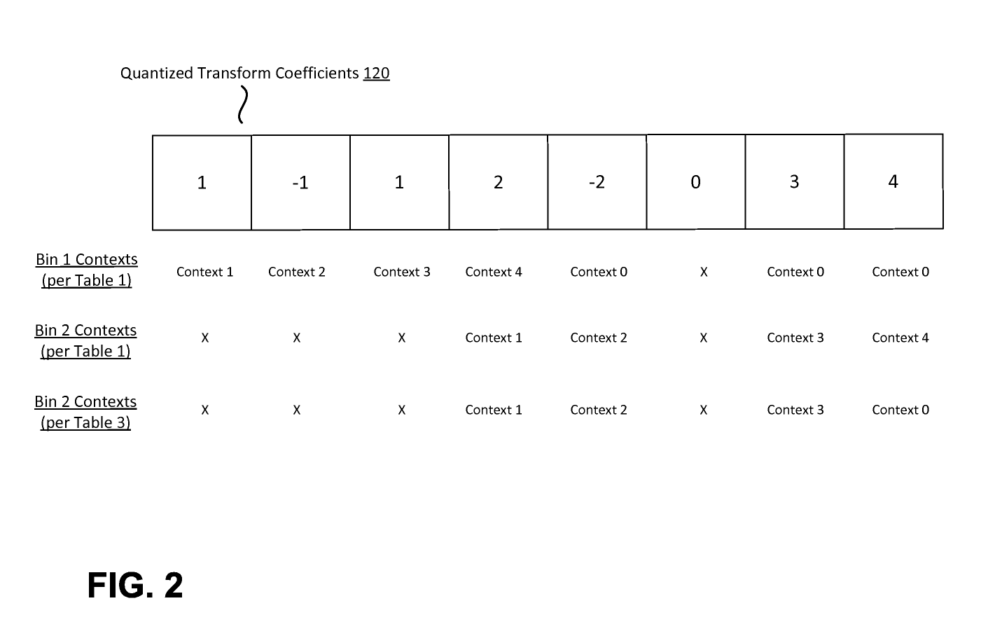

FIG. 2 is a conceptual diagram illustrating an example CABAC process according to this disclosure. As illustrated in FIG. 2, a vector of quantized transform coefficients 120 may include coefficients are 1, −1, 1, 2, −2, −2, 0, 3, and 4. Applying the rules in Table 1 for contexts for model bin 1 leads to the contexts illustrated in FIG. 2.

As illustrated, the first context for model bin 1 is context 1. Context 1 is chosen for coding bin 1 for the first coefficient in the vector as it is the initial value with no trailing “1s”.

Context 2 is chosen for coding bin 1 for the second coefficient in the vector as there is one trailing “1.” That is, the absolute values of at least one previously coded transform coefficients has a value of 1 (e.g., the first coefficient in the vector has an absolute value of 1).

Context 3 is chosen for coding bin 1 for the third coefficient in the vector as there are two trailing “1s.” That is, the absolute values of at least two previously coded transform coefficients have a value of 1 (e.g., both the first and second coefficient in the vector has an absolute value of 1).

Context 4 is chosen for coding bin 1 for the fourth coefficient in the vector as there are three or more trailing “1s.” That is, the absolute values of at least three previously coded transform coefficients have a value of 1 (e.g., both the first, second, and third coefficient in the vector has an absolute value of 1).

Context 0 is chosen for coding bin 1 for the fifth coefficients in the vector as a coefficient has been encoded that is larger than 1. That is, the absolute value of a previously coded transform coefficients has an absolute value greater than 1 (e.g., the fourth coefficient in the vector has an absolute value of 2).

Applying the rules for contexts for bin 1 leads to no value being encoded for the sixth coefficient, X. (An “X” indicates that no bin 1 value is coded for that coefficient.) This is because it is already known from the significance map coding that the value is not greater than 0. Accordingly, the value cannot be greater than 1.

Context 0 is chosen for coding bin 1 for the seventh and eighth coefficients in the vector as a coefficient has been encoded that is larger than 1. That is, the absolute value of a previously coded transform coefficients has an absolute value greater than 1 (e.g., the fourth coefficient in the vector has an absolute value of 2).

Previous rules for model bin 2 are also summarized in Table 1. Applying the rules for contexts for bin 2 for the rules under Table 1 leads to no value being encoded for the first to three coefficients, X, X, X. (An “X” indicates that no bin 2 value is coded for that coefficient.) This is because the bin 1 coding indicates that the value is not greater than 1 and therefore cannot be greater than 2.

Context 1 is chosen for coding bin 2 for the fourth coefficient in the vector as there is one bin 1 value coded as 1. That is, the absolute values of one previously coded transform coefficient for bin 1 has a value of 1 (e.g., the first coefficient in bin 1 is coded as 1).

Context 2 is chosen for coding bin 2 for the fifth coefficient in the vector as there are two bin 1 values coded as 1. That is, the absolute values of at least two previously coded transform coefficients for bin 1 have a value of 1 (e.g., both the first and second coefficient in bin 1 has an absolute value of 1).

No value is encoded for coefficient six. (Another “X” indicating that no bin 2 value is coded for that coefficient.) This is because the bin 1 coding (also an “X”) indicates that no value should be coded for the coefficient.

Context 3 is chosen for coding bin 2 for the seventh coefficient in the vector as there are three trailing values larger than “1.” That is, the absolute values of at least three previously coded transform coefficients for bin 1 have a value of 1 (e.g., both the first, second, and third coefficient in the vector has an absolute value of 1).

Context 4 is chosen for coding bin 2 for the eighth coefficient in the vector as there are three trailing values larger than “1.” That is, the absolute values of at least three previously coded transform coefficients for bin 1 have a value of 1 (e.g., both the first, second, and third coefficient in the vector has an absolute value of 1).

Applying the proposed rules of Table 3, the contexts for bin 2, for the coefficients 1, −1, 1, 2, −2, −2, 0, 3, and −4 are X, X, X, followed by context 1 context 2, X, context 3, and context 0. As can be seen, for this example, the context selected for the eighth coefficient in the vector is different from the rules for bin 2 shown in Table 1. Under the proposed rules in Table 3, context 0 is chosen for coding bin 2 for the eighth coefficient in the vector as there is at least one bin 2 value coded as “2.” That is, the absolute values of at least one previously coded transform coefficients for bin 2 has an absolute value of 2 (e.g., the seventh coefficient in the vector has an absolute value of 3). In this way, more current information concerning bin 2 coding (i.e., whether or not a coefficient has an absolute value of greater than 2) is taken into account when choosing a context for coding subsequent bin 2 values.

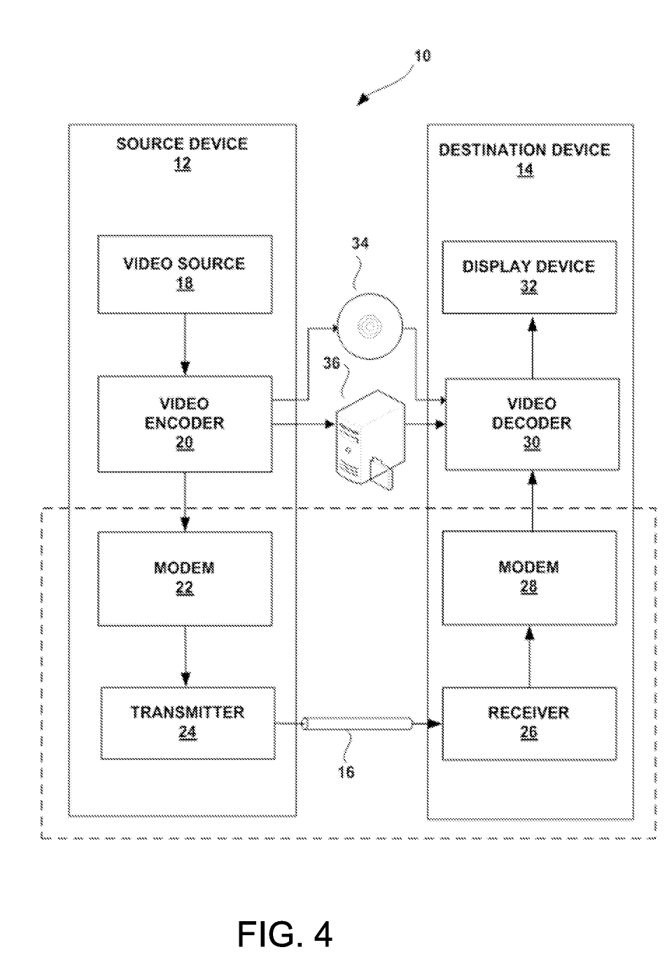

FIG. 4 below is a block diagram illustrating an example video encoding and decoding system 10 that may be configured to utilize techniques for entropy coding in accordance with examples of this disclosure. As shown in FIG. 4, the system 10 includes a source device 12 that transmits encoded video to a destination device 14 via a communication channel 16. Encoded video data may also be stored on a storage medium 34 or a file server 36 and may be accessed by the destination device 14 as desired. When stored to a storage medium or file server, video encoder 20 may provide coded video data to another device, such as a network interface, a compact disc (CD), Blu-ray or digital video disc (DVD) burner or stamping facility device, or other devices, for storing the coded video data to the storage medium. Likewise, a device separate from video decoder 30, such as a network interface, CD or DVD reader, or the like, may retrieve coded video data from a storage medium and provided the retrieved data to video decoder 30.

The source device 12 and the destination device 14 may comprise any of a wide variety of devices, including desktop computers, notebook (i.e., laptop) computers, tablet computers, set-top boxes, telephone handsets such as so-called smartphones, televisions, cameras, display devices, digital media players, video gaming consoles, or the like. In many cases, such devices may be equipped for wireless communication. Hence, the communication channel 16 may comprise a wireless channel, a wired channel, or a combination of wireless and wired channels suitable for transmission of encoded video data. Similarly, the file server 36 may be accessed by the destination device 14 through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server.

Techniques for entropy coding, in accordance with examples of this disclosure, may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, the system 10 may be configured to support one-way or two-way video transmission to support applications such as video streaming, video playback, video broadcasting, and/or video telephony.

In the example of FIG. 4, the source device 12 includes a video source 18, a video encoder 20, a modulator/demodulator 22 and a transmitter 24. In the source device 12, the video source 18 may include a source such as a video capture device, such as a video camera, a video archive containing previously captured video, a video feed interface to receive video from a video content provider, and/or a computer graphics system for generating computer graphics data as the source video, or a combination of such sources. As one example, if the video source 18 is a video camera, the source device 12 and the destination device 14 may form so-called camera phones or video phones. However, the techniques described in this disclosure may be applicable to video coding in general, and may be applied to wireless and/or wired applications, or application in which encoded video data is stored on a local disk.

The captured, pre-captured, or computer-generated video may be encoded by the video encoder 20. The encoded video information may be modulated by the modem 22 according to a communication standard, such as a wireless communication protocol, and transmitted to the destination device 14 via the transmitter 24. The modem 22 may include various mixers, filters, amplifiers or other components designed for signal modulation. The transmitter 24 may include circuits designed for transmitting data, including amplifiers, filters, and one or more antennas.

The captured, pre-captured, or computer-generated video that is encoded by the video encoder 20 may also be stored onto a storage medium 34 or a file server 36 for later consumption. The storage medium 34 may include Blu-ray discs, DVDs, CD-ROMs, flash memory, or any other suitable digital storage media for storing encoded video. The encoded video stored on the storage medium 34 may then be accessed by the destination device 14 for decoding and playback.

The file server 36 may be any type of server capable of storing encoded video and transmitting that encoded video to the destination device 14. Example file servers include a web server (e.g., for a website), an FTP server, network attached storage (NAS) devices, a local disk drive, or any other type of device capable of storing encoded video data and transmitting it to a destination device. The transmission of encoded video data from the file server 36 may be a streaming transmission, a download transmission, or a combination of both. The file server 36 may be accessed by the destination device 14 through any standard data connection, including an Internet connection. This may include a wireless channel (e.g., a Wi-Fi connection), a wired connection (e.g., DSL, cable modem, Ethernet, USB, etc.), or a combination of both that is suitable for accessing encoded video data stored on a file server.

The destination device 14, in the example of FIG. 4, includes a receiver 26, a modem 28, a video decoder 30, and a display device 32. The receiver 26 of the destination device 14 receives information over the channel 16, and the modem 28 demodulates the information to produce a demodulated bitstream for the video decoder 30. The information communicated over the channel 16 may include a variety of syntax information generated by the video encoder 20 for use by the video decoder 30 in decoding video data. Such syntax may also be included with the encoded video data stored on the storage medium 34 or the file server 36. Each of the video encoder 20 and the video decoder 30 may form part of a respective encoder-decoder (CODEC) that is capable of encoding or decoding video data.

The display device 32 may be integrated with, or external to, the destination device 14. In some examples, the destination device 14 may include an integrated display device and also be configured to interface with an external display device. In other examples, the destination device 14 may be a display device. In general, the display device 32 displays the decoded video data to a user, and may comprise any of a variety of display devices such as a liquid crystal display (LCD), a plasma display, an organic light emitting diode (OLED) display, or another type of display device.

In the example of FIG. 4, the communication channel 16 may comprise any wireless or wired communication medium, such as a radio frequency (RF) spectrum or one or more physical transmission lines, or any combination of wireless and wired media. The communication channel 16 may form part of a packet-based network, such as a local area network, a wide-area network, or a global network such as the Internet. The communication channel 16 generally represents any suitable communication medium, or collection of different communication media, for transmitting video data from the source device 12 to the destination device 14, including any suitable combination of wired or wireless media. The communication channel 16 may include routers, switches, base stations, or any other equipment that may be useful to facilitate communication from the source device 12 to the destination device 14.

The video encoder 20 and the video decoder 30 may operate according to a video compression standard, such as the High Efficiency Video Coding (HEVC) standard presently under development, and may conform to the HEVC Test Model (HM). Alternatively, the video encoder 20 and the video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples include MPEG-2 and ITU-T H.263.

Although not shown in FIG. 4, in some aspects, the video encoder 20 and the video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

The video encoder 20 and the video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of the video encoder 20 and the video decoder 30 may be included in one or more encoders or decoders, either of which may be integrated as part of a combined encoder/decoder (CODEC) in a respective device.

The video encoder 20 may implement any or all of the techniques of this disclosure for entropy coding in a video encoding process. Likewise, the video decoder 30 may implement any or all of these techniques for entropy coding in a video coding process. A video coder, as described in this disclosure, may refer to a video encoder or a video decoder. Similarly, a video coding unit may refer to a video encoder or a video decoder. Likewise, video coding may refer to video encoding or video decoding.

An example method of coding transform coefficients in a video coding process may be implemented by video encoder 20 and video decoder 30. In the example method, video encoder 20 or video decoder may be configured to select a bin 2 context for coding a bin 2 level of each transform coefficient in a vector according to an entropy coding process. Video encoder 20 or video decoder 30 may code the bin 2 level of each transform coefficient in the vector according to a selected bin 2 context. Selecting the bin 2 context may include selecting the bin 2 context for a current transform coefficient in the vector based on the bin 2 level of one or more previously coded transform coefficients in the vector.

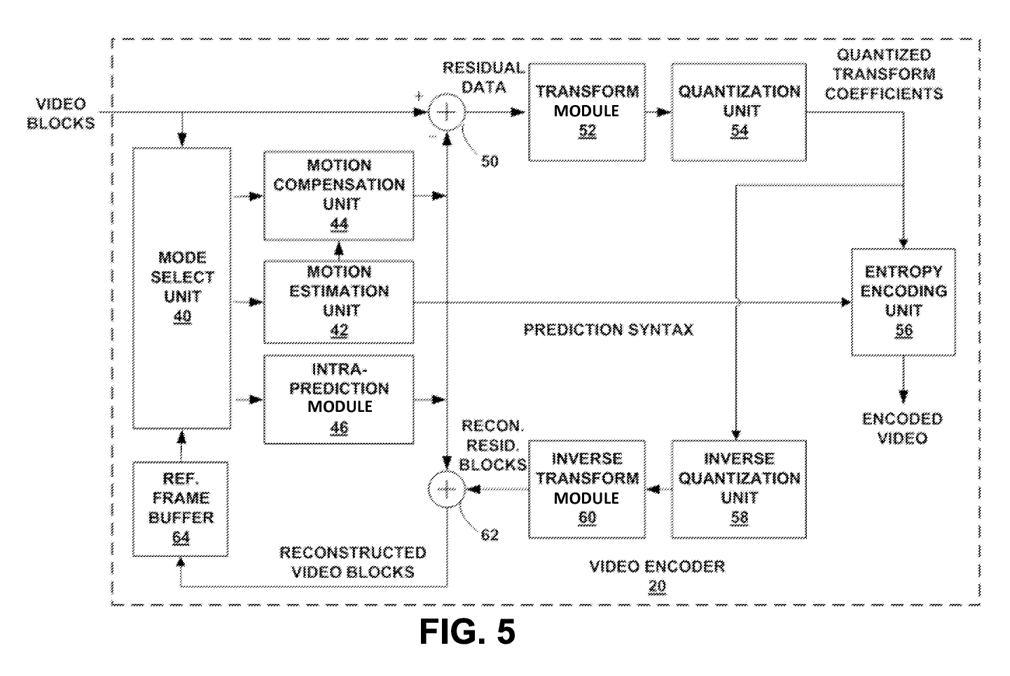

FIG. 5 below is a block diagram illustrating an example of a video encoder 20 that may use techniques for entropy coding as described in this disclosure. The video encoder 20 will be described in the context of HEVC coding for purposes of illustration, but without limitation of this disclosure as to other coding standards or methods that may require scanning of transform coefficients. The video encoder 20 may perform intra- and inter-coding of CUs within video frames. Intra-coding relies on spatial prediction to reduce or remove spatial redundancy in video data within a given video frame. Inter-coding relies on temporal prediction to reduce or remove temporal redundancy between a current frame and previously coded frames of a video sequence. Intra-mode (I-mode) may refer to any of several spatial-based video compression modes. Inter-modes such as uni-directional prediction (P-mode) or bi-directional prediction (B-mode) may refer to any of several temporal-based video compression modes.

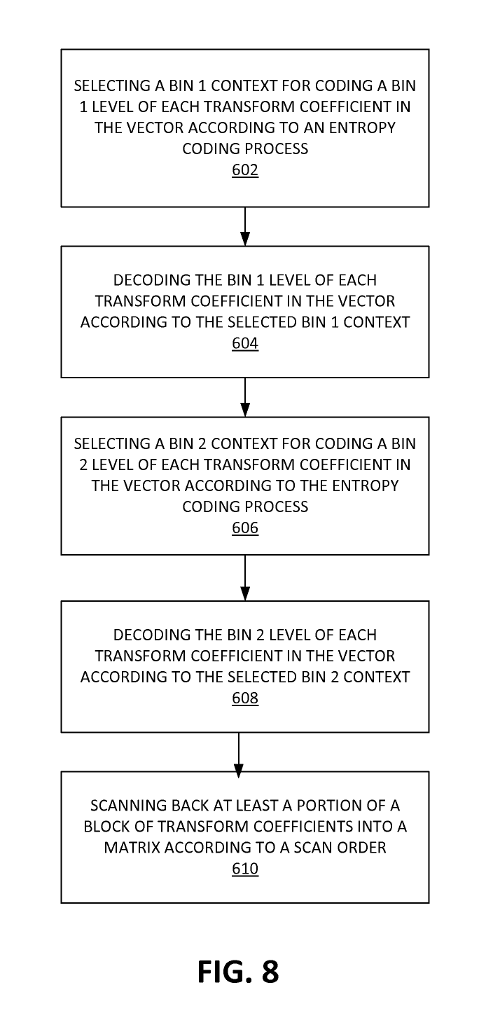

As shown in FIG. 5, the video encoder 20 receives a current video block within a video frame to be encoded. In the example of FIG. 8, the video encoder 20 includes a motion compensation unit 44, a motion estimation unit 42, an intra-prediction module 46, a reference frame buffer 64, a summer 50, a transform module 52, a quantization unit 54, and an entropy encoding unit 56. The transform module 52 illustrated in FIG. 5 is the unit that applies the actual transform or combinations of transform to a block of residual data, and is not to be confused with block of transform coefficients, which also may be referred to as a transform unit (TU) of a CU. For video block reconstruction, the video encoder 20 also includes an inverse quantization unit 58, an inverse transform module 60, and a summer 62. A deblocking filter (not shown in FIG. 5) may also be included to filter block boundaries to remove blockiness artifacts from reconstructed video. If desired, the deblocking filter would typically filter the output of the summer 62.

During the encoding process, the video encoder 20 receives a video frame or slice to be coded. The frame or slice may be divided into multiple video blocks, e.g., largest coding units (LCUs). The motion estimation unit 42 and the motion compensation unit 44 perform inter-predictive coding of the received video block relative to one or more blocks in one or more reference frames to provide temporal compression. The intra-prediction module 46 may perform intra-predictive coding of the received video block relative to one or more neighboring blocks in the same frame or slice as the block to be coded to provide spatial compression.

The mode select unit 40 may select one of the coding modes, intra or inter, e.g., based on error (i.e., distortion) results for each mode, and provides the resulting intra- or inter-predicted block (e.g., a prediction unit (PU)) to the summer 50 to generate residual block data and to the summer 62 to reconstruct the encoded block for use in a reference frame. Summer 62 combines the predicted block with inverse quantized, inverse transformed data from inverse transform module 60 for the block to reconstruct the encoded block, as described in greater detail below. Some video frames may be designated as I-frames, where all blocks in an I-frame are encoded in an intra-prediction mode. In some cases, the intra-prediction module 46 may perform intra-prediction encoding of a block in a P- or B-frame, e.g., when motion search performed by the motion estimation unit 42 does not result in a sufficient prediction of the block.

The motion estimation unit 42 and the motion compensation unit 44 may be highly integrated, but are illustrated separately for conceptual purposes. Motion estimation (or motion search) is the process of generating motion vectors, which estimate motion for video blocks. A motion vector, for example, may indicate the displacement of a prediction unit in a current frame relative to a reference sample of a reference frame. The motion estimation unit 42 calculates a motion vector for a prediction unit of an inter-coded frame by comparing the prediction unit to reference samples of a reference frame stored in the reference frame buffer 64. A reference sample may be a block that is found to closely match the portion of the CU including the PU being coded in terms of pixel difference, which may be determined by sum of absolute difference (SAD), sum of squared difference (SSD), or other difference metrics. The reference sample may occur anywhere within a reference frame or reference slice, and not necessarily at a block (e.g., coding unit) boundary of the reference frame or slice. In some examples, the reference sample may occur at a fractional pixel position.

The motion estimation unit 42 sends the calculated motion vector to the entropy encoding unit 56 and the motion compensation unit 44. The portion of the reference frame identified by a motion vector may be referred to as a reference sample. The motion compensation unit 44 may calculate a prediction value for a prediction unit of a current CU, e.g., by retrieving the reference sample identified by a motion vector for the PU.

The intra-prediction module 46 may intra-predict the received block, as an alternative to inter-prediction performed by the motion estimation unit 42 and the motion compensation unit 44. The intra-prediction module 46 may predict the received block relative to neighboring, previously coded blocks, e.g., blocks above, above and to the right, above and to the left, or to the left of the current block, assuming a left-to-right, top-to-bottom encoding order for blocks. The intra-prediction module 46 may be configured with a variety of different intra-prediction modes. For example, the intra-prediction module 46 may be configured with a certain number of directional prediction modes, e.g., thirty-five directional prediction modes, based on the size of the CU being encoded.

The intra-prediction module 46 may select an intra-prediction mode by, for example, calculating error values for various intra-prediction modes and selecting a mode that yields the lowest error value. Directional prediction modes may include functions for combining values of spatially neighboring pixels and applying the combined values to one or more pixel positions in a PU. Once values for all pixel positions in the PU have been calculated, the intra-prediction unit 46 may calculate an error value for the prediction mode based on pixel differences between the PU and the received block to be encoded. The intra-prediction module 46 may continue testing intra-prediction modes until an intra-prediction mode that yields an acceptable error value is discovered. The intra-prediction module 46 may then send the PU to the summer 50.

The video encoder 20 forms a residual block by subtracting the prediction data calculated by the motion compensation unit 44 or the intra-prediction module 46 from the original video block being coded. The summer 50 represents the component or components that perform this subtraction operation. The residual block may correspond to a two-dimensional matrix of pixel difference values, where the number of values in the residual block is the same as the number of pixels in the PU corresponding to the residual block. The values in the residual block may correspond to the differences, i.e., error, between values of co-located pixels in the PU and in the original block to be coded. The differences may be chroma or luma differences depending on the type of block that is coded.

The transform module 52 may form one or more transform units (TUs) from the residual block. The transform module 52 selects a transform from among a plurality of transforms. The transform may be selected based on one or more coding characteristics, such as block size, coding mode, or the like. The transform module 52 then applies the selected transform to the TU, producing a video block comprising a two-dimensional array of transform coefficients. The transform module 52 may select the transform partition according to above-described techniques of this disclosure. In addition, the transform module 52 may signal the selected transform partition in the encoded video bitstream.

The transform module 52 may send the resulting transform coefficients to the quantization unit 54. The quantization unit 54 may then quantize the transform coefficients. The entropy encoding unit 56 may then perform a scan of the quantized transform coefficients in the matrix according to a scanning mode. This disclosure describes the entropy encoding unit 56 as performing the scan. However, it should be understood that, in other examples, other processing units, such as the quantization unit 54, could perform the scan.

Once the transform coefficients are scanned into the one-dimensional array, the entropy encoding unit 56 may apply entropy coding such as CAVLC, CABAC, syntax-based context-adaptive binary arithmetic coding (SBAC), or another entropy coding methodology to the coefficients.

To perform CAVLC, the entropy encoding unit 56 may select a variable length code for a symbol to be transmitted. Codewords in VLC may be constructed such that relatively shorter codes correspond to more likely symbols, while longer codes correspond to less likely symbols. In this way, the use of VLC may achieve a bit savings over, for example, using equal-length codewords for each symbol to be transmitted.

To perform CABAC, the entropy encoding unit 56 may select a context model to apply to a certain context to encode symbols to be transmitted. The context may relate to, for example, whether neighboring values are non-zero or not. The entropy encoding unit 56 may also entropy encode syntax elements, such as the signal representative of the selected transform. In accordance with the techniques of this disclosure, the entropy encoding unit 56 may select the context model used to encode these syntax elements based on, for example, an intra-prediction direction for intra-prediction modes, a scan position of the coefficient corresponding to the syntax elements, block type, and/or transform type, among other factors used for context model selection. According to examples of this disclosure, entropy encoding unit 56 may be configured to select a bin 2 context for coding a bin 2 level of each transform coefficient in a vector according to an entropy coding process may be selected. Entropy encoding unit 56 may code the bin 2 level of each transform coefficient in the vector according to a selected bin 2 context. Selecting the bin 2 context may include selecting the bin 2 context for a current transform coefficient in the vector based on the bin 2 level of one or more previously coded transform coefficients in the vector.

Following the entropy coding by the entropy encoding unit 56, the resulting encoded video may be transmitted to another device, such as the video decoder 30, or archived for later transmission or retrieval.

In some cases, the entropy encoding unit 56 or another unit of the video encoder 20 may be configured to perform other coding functions, in addition to entropy coding. For example, the entropy encoding unit 56 may be configured to determine coded block pattern (CBP) values for CU's and PU's. Also, in some cases, the entropy encoding unit 56 may perform run length coding of coefficients.

The inverse quantization unit 58 and the inverse transform module 60 apply inverse quantization and inverse transformation, respectively, to reconstruct the residual block in the pixel domain, e.g., for later use as a reference block. The motion compensation unit 44 may calculate a reference block by adding the residual block to a predictive block of one of the frames of the reference frame buffer 64. The motion compensation unit 44 may also apply one or more interpolation filters to the reconstructed residual block to calculate sub-integer pixel values for use in motion estimation. The summer 62 adds the reconstructed residual block to the motion compensated prediction block produced by the motion compensation unit 44 to produce a reconstructed video block for storage in the reference frame buffer 64. The reconstructed video block may be used by the motion estimation unit 42 and the motion compensation unit 44 as a reference block to inter-code a block in a subsequent video frame.

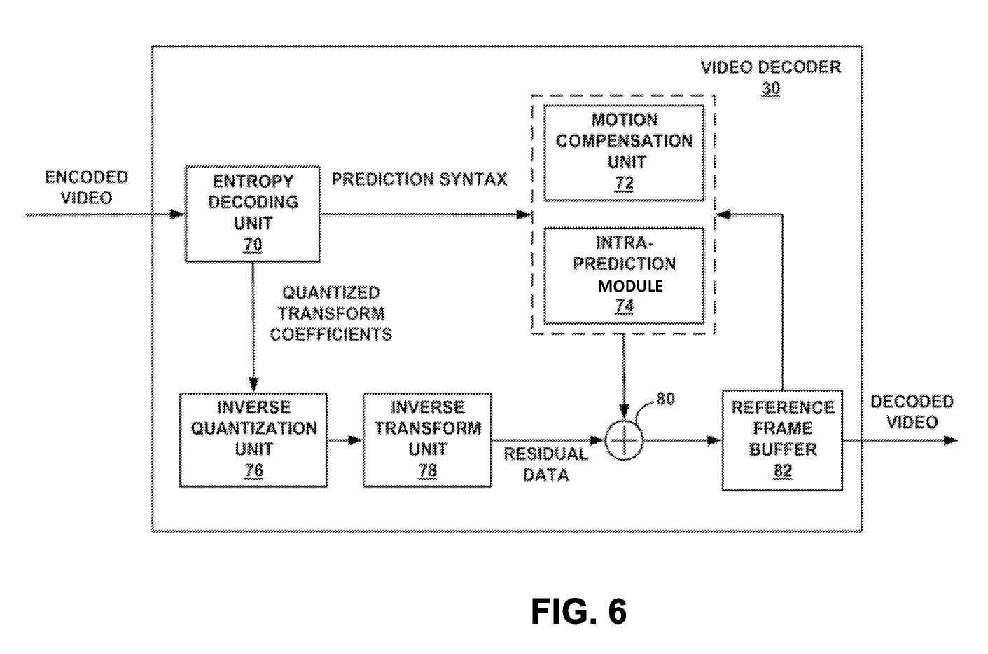

FIG. 6 below is a block diagram illustrating an example of a video decoder 30, which decodes an encoded video sequence. In the example of FIG. 8, the video decoder 30 includes an entropy decoding unit 70, a motion compensation unit 72, an intra-prediction module 74, an inverse quantization unit 76, an inverse transformation unit 78, a reference frame buffer 82 and a summer 80. The video decoder 30 may, in some examples, perform a decoding pass generally reciprocal to the encoding pass described with respect to the video encoder 20 (see FIG. 5).

The entropy decoding unit 70 performs an entropy decoding process on the encoded bitstream to retrieve a one-dimensional array of transform coefficients. The entropy decoding process used depends on the entropy coding used by the video encoder 20 (e.g., CABAC, CAVLC, etc.). The entropy coding process used by the encoder may be signaled in the encoded bitstream or may be a predetermined process.

In some examples, the entropy decoding unit 70 (or the inverse quantization unit 76) may scan the received values using a scan mirroring the scanning mode used by the entropy encoding unit 56 (or the quantization unit 54) of the video encoder 20. Although the scanning of coefficients may be performed in the inverse quantization unit 76, scanning will be described for purposes of illustration as being performed by the entropy decoding unit 70. In addition, although shown as separate functional units for ease of illustration, the structure and functionality of the entropy decoding unit 70, the inverse quantization unit 76, and other units of the video decoder 30 may be highly integrated with one another. According to examples of this disclosure, entropy decoding unit 70 may be configured to select a bin 2 context for coding a bin 2 level of each transform coefficient in a vector according to an entropy coding process may be selected. Entropy decoding unit 70 may code the bin 2 level of each transform coefficient in the vector according to a selected bin 2 context. Selecting the bin 2 context may include selecting the bin 2 context for a current transform coefficient in the vector based on the bin 2 level of one or more previously coded transform coefficients in the vector.

The inverse quantization unit 76 inverse quantizes, i.e., de-quantizes, the quantized transform coefficients provided in the bitstream and decoded by the entropy decoding unit 70. The inverse quantization process may include a conventional process, e.g., similar to the processes proposed for HEVC or defined by the H.264 decoding standard. The inverse quantization process may include use of a quantization parameter QP calculated by the video encoder 20 for the CU to determine a degree of quantization and, likewise, a degree of inverse quantization that should be applied. The inverse quantization unit 76 may inverse quantize the transform coefficients either before or after the coefficients are converted from a one-dimensional array to a two-dimensional array.

The inverse transform module 78 applies an inverse transform to the inverse quantized transform coefficients. In some examples, the inverse transform module 78 may determine an inverse transform based on signaling from the video encoder 20, or by inferring the transform from one or more coding characteristics such as block size, coding mode, or the like. In some examples, the inverse transform module 78 may determine a transform to apply to the current block based on a signaled transform at the root node of a quadtree for an LCU including the current block. Alternatively, the transform may be signaled at the root of a TU quadtree for a leaf-node CU in the LCU quadtree. In some examples, the inverse transform module 78 may apply a cascaded inverse transform, in which inverse transform module 78 applies two or more inverse transforms to the transform coefficients of the current block being decoded.

In addition, the inverse transform unit may apply the inverse transform to produce a transform unit partition in accordance with the above-described techniques of this disclosure.

The intra-prediction module 74 may generate prediction data for a current block of a current frame based on a signaled intra-prediction mode and data from previously decoded blocks of the current frame.

Based on the retrieved motion prediction direction, reference frame index, and calculated current motion vector, the motion compensation unit produces a motion compensated block for the current portion. These motion compensated blocks essentially recreate the predictive block used to produce the residual data.

The motion compensation unit 72 may produce the motion compensated blocks, possibly performing interpolation based on interpolation filters. Identifiers for interpolation filters to be used for motion estimation with sub-pixel precision may be included in the syntax elements. The motion compensation unit 72 may use interpolation filters as used by the video encoder 20 during encoding of the video block to calculate interpolated values for sub-integer pixels of a reference block. The motion compensation unit 72 may determine the interpolation filters used by the video encoder 20 according to received syntax information and use the interpolation filters to produce predictive blocks.

Additionally, the motion compensation unit 72 and the intra-prediction module 74, in an HEVC example, may use some of the syntax information (e.g., provided by a quadtree) to determine sizes of LCUs used to encode frame(s) of the encoded video sequence. The motion compensation unit 72 and the intra-prediction module 74 may also use syntax information to determine split information that describes how each CU of a frame of the encoded video sequence is split (and likewise, how sub-CUs are split). The syntax information may also include modes indicating how each split is encoded (e.g., intra- or inter-prediction, and for intra-prediction an intra-prediction encoding mode), one or more reference frames (and/or reference lists containing identifiers for the reference frames) for each inter-encoded PU, and other information to decode the encoded video sequence.

The summer 80 combines the residual blocks with the corresponding prediction blocks generated by the motion compensation unit 72 or the intra-prediction module 74 to form decoded blocks. If desired, a deblocking filter may also be applied to filter the decoded blocks in order to remove blockiness artifacts. The decoded video blocks are then stored in the reference frame buffer 82, which provides reference blocks for subsequent motion compensation and also produces decoded video for presentation on a display device (such as the display device 32 of FIG. 4).

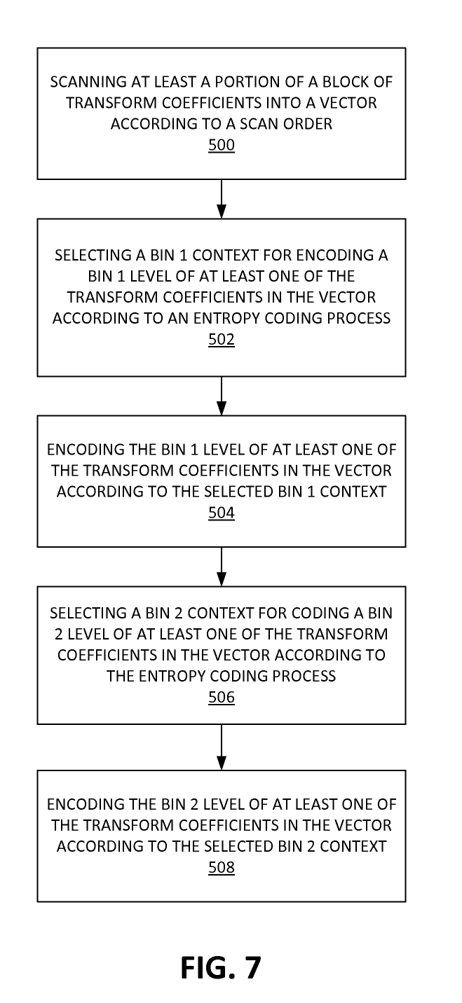

FIG. 7 is a flow diagram illustrating and example method of encoding transform coefficients in a video coding process in accordance with the systems and methods described herein. The method of FIG. 7 may be implemented, for example, by video encoder 20. In step 500, video encoder 20 is configured to scan at least a portion of a block of transform coefficients into a vector according to a scan order.

In step 502, video encoder 20 is configured to select a bin 1 context for coding a bin 1 level of one or more transform coefficients in the vector according to an entropy coding process. The entropy coding process may be a CABAC process.

In step 504, video encoder 20 is configured to encode the bin 1 level of one or more transform coefficients in the vector according to the selected bin 1 context. Video encoder 20 may be configured to select the bin 1 context for a current transform coefficient in the vector based on the bin 1 level of one or more previously coded transform coefficients in the vector. In some examples the coding of bin 1 and bin 2 might be interleaved.

In step 506, video encoder 20 is configured to select a bin 2 context for coding a bin 2 level of one or more transform coefficients in the vector according to the entropy coding process. Video encoder 20 may be configured to select the bin 2 context for a current transform coefficient in the vector based on the bin 2 level of one or more previously coded transform coefficients in the vector. Selecting the bin 2 context may also include selecting a bin 2 context from a context model containing any number of bin 2 contexts. In some specific examples, there may be 4 or 5 contexts for selection (e.g., see Tables 3 and 4). Additionally, selecting the bin 2 context might include selecting the bin 2 context for a current transform coefficient in the vector based on the bin 2 level of one or more previously coded transform coefficients in a transform unit.

For the example of a context set including 5 contexts, a first bin 2 context may be selected in the case that the current transform coefficient is a first transform coefficient in the vector along the scan order having a value of 2. A second bin 2 context may be selected in the case that the current transform coefficient is preceded by one previously coded transform coefficient in the vector along the scan order having a value of 2. A third bin 2 context may be selected in the case that the current transform coefficient is preceded by two previously coded transform coefficients in the vector along the scan order having a value of 2. A fourth bin 2 context may be selected in the case that the current transform coefficient is preceded by three or more previously coded transform coefficients in the vector along the scan order having a value of 2. A fifth bin 2 context may be selected in the case that the current transform coefficient is preceded by any previously coded transform coefficient in the vector along the scan order having a value greater than 2.

For the example of a context set including 4 contexts, a first bin 2 context may be selected in the case that the current transform coefficient is a first transform coefficient in the vector along the scan order having a value of 2. A second bin 2 context may be selected in the case that the current transform coefficient is preceded by one previously coded transform coefficient in the vector along the scan order having a value of 2. A third bin 2 context may be selected in the case that the current transform coefficient is preceded by two or more previously coded transform coefficients in the vector along the scan order having a value of 2. A fourth bin 2 context may be selected in the case that the current transform coefficient is preceded by any previously coded transform coefficient in the vector along the scan order having a value greater than 2.

In step 508, video encoder 20 may be configured to code the bin 2 level of one or more transform coefficients in the vector according to the selected bin 2 context.

FIG. 8 is a flow diagram illustrating and example method of decoding transform coefficients in a video coding process in accordance with the systems and methods described herein. The method of FIG. 8 may be implemented, for example, by video decoder 30.

In step 602, video decoder 30 is configured to select a bin 1 context for decoding a bin 1 level of one or more transform coefficients in the vector according to an entropy coding process. The entropy coding process may be a CABAC process.

In step 604, video decoder 30 is configured to decode the bin 1 level of one or more transform coefficients in the vector according to the selected bin 1 context. Video decoder 30 may be configured to select the bin 1 context for a current transform coefficient in the vector based on the bin 1 level of one or more previously coded transform coefficients in the vector.

In step 606, video decoder 30 is configured to select a bin 2 context for decoding a bin 2 level of one or more transform coefficients in the vector according to the entropy coding process. Video decoder 30 may be configured to select the bin 2 context for a current transform coefficient in the vector based on the bin 2 level of one or more previously coded transform coefficients in the vector. Selecting the bin 2 context may also include selecting a bin 2 context from a context model containing any number of bin 2 contexts. In some specific examples, there may be 4 or 5 contexts for selection (e.g., see Tables 3 and 4).

A first bin 2 context may be selected in the case that the current transform coefficient is a first transform coefficient in the vector along the scan order having a value of 2. A second bin 2 context may be selected in the case that the current transform coefficient is preceded by one previously coded transform coefficient in the vector along the scan order having a value of 2. A third bin 2 context may be selected in the case that the current transform coefficient is preceded by two previously coded transform coefficients in the vector along the scan order having a value of 2. A fourth bin 2 context may be selected in the case that the current transform coefficient is preceded by three or more previously coded transform coefficients in the vector along the scan order having a value of 2. A fifth bin 2 context may be selected in the case that the current transform coefficient is preceded by any previously coded transform coefficient in the vector along the scan order having a value greater than 2.

In another example, selecting a bin 2 context includes selecting a bin 2 context from a context model containing four bin 2 contexts.

In another example, a first bin 2 context may be selected in the case that the current transform coefficient is a first transform coefficient in the vector along the scan order having a value of 2. A second bin 2 context may be selected in the case that the current transform coefficient is preceded by one previously coded transform coefficient in the vector along the scan order having a value of 2. A third bin 2 context may be selected in the case that the current transform coefficient is preceded by two or more previously coded transform coefficients in the vector along the scan order having a value of 2. A fourth bin 2 context may be selected in the case that the current transform coefficient is preceded by any previously coded transform coefficient in the vector along the scan order having a value greater than 2.

In step 608, video decoder 30 may be configured to code the bin 2 level of one or more transform coefficients in the vector according to the selected bin 2 context.

In step 610, video decoder 30 may be configured to scan at least a portion of a block of transform coefficients back into a matrix of quantized transform coefficients according to a scan order.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding transform coefficients in a video coding process comprising:
selecting a bin 2 context for coding a bin 2 level of one or more transform coefficients in the vector according to the entropy coding process; and
coding the bin 2 level of one or more transform coefficients in the vector according to the selected bin 2 context, wherein selecting the bin 2 context comprises selecting the bin 2 context for a current transform coefficient in the vector based on the bin 2 level of one or more previously coded transform coefficients in a transform unit

2. The method of claim 1, further comprising scanning at least a portion of a block of transform coefficients into a vector according to a scan order and wherein selecting the bin 2 context comprises selecting the bin 2 context for a current transform coefficient in the vector based on the bin 2 level of one or more previously coded transform coefficients in the vector.

3. The method of claim 1, wherein the entropy coding process is a CABAC process.

4. The method of claim 1, wherein selecting a bin 2 context includes selecting a bin 2 context from a context model containing five bin 2 contexts.

5. The method of claim 4,
wherein a first bin 2 context is selected in the case that the current transform coefficient is a first transform coefficient in the vector along the scan order having a value of 2, and
wherein a second bin 2 context is selected in the case that the current transform coefficient is preceded by one previously coded transform coefficient in the vector along the scan order having a value of 2.

6. The method of claim 5,
wherein a third bin 2 context is selected in the case that the current transform coefficient is preceded by two previously coded transform coefficients in the vector along the scan order having a value of 2,
wherein a fourth bin 2 context is selected in the case that the current transform coefficient is preceded by three or more previously coded transform coefficients in the vector along the scan order having a value of 2, and
wherein a fifth bin 2 context is selected in the case that the current transform coefficient is preceded by any previously coded transform coefficient in the vector along the scan order having a value greater than 2.

7. The method of claim 1, wherein selecting a bin 2 context includes selecting a bin 2 context from a context model containing four bin 2 contexts.

8. The method of claim 7,
wherein a first bin 2 context is selected in the case that the current transform coefficient is a first transform coefficient in the vector along the scan order having a value of 2,
wherein a second bin 2 context is selected in the case that the current transform coefficient is preceded by one previously coded transform coefficient in the vector along the scan order having a value of 2,
wherein a third bin 2 context is selected in the case that the current transform coefficient is preceded by two or more previously coded transform coefficients in the vector along the scan order having a value of 2, and
wherein a fourth bin 2 context is selected in the case that the current transform coefficient is preceded by any previously coded transform coefficient in the vector along the scan order having a value greater than 2.

9. The method of claim 1, wherein the video coding process is a video encoding process.

10. The method of claim 1, wherein the video coding process is a video decoding process.

11. An apparatus for coding transform coefficients in a video coding process comprising:
means for selecting a bin 2 context for coding a bin 2 level of one or more transform coefficients in the vector according to the entropy coding process; and
means for coding the bin 2 level of one or more transform coefficients in the vector according to the selected bin 2 context,
wherein selecting the bin 2 context comprises selecting the bin 2 context for a current transform coefficient in the vector based on the bin 2 level of one or more previously coded transform coefficients in a transform unit

12. The apparatus of claim 11, further comprising means for scanning at least a portion of a block of transform coefficients into a vector according to a scan order and wherein the selecting the bin 2 context comprises selecting the bin 2 context for a current transform coefficient in the vector based on the bin 2 level of one or more previously coded transform coefficients in the vector.

13. The apparatus of claim 11, wherein the entropy coding process is a CABAC process.

14. The apparatus of claim 11, wherein means for selecting a bin 2 context includes means for selecting a bin 2 context from a context model containing five bin 2 contexts.

15. The apparatus of claim 14,
wherein a first bin 2 context is selected in the case that the current transform coefficient is a first transform coefficient in the vector along the scan order having a value of 2,
wherein a second bin 2 context is selected in the case that the current transform coefficient is preceded by one previously coded transform coefficient in the vector along the scan order having a value of 2.

16. The apparatus of claim 15,
wherein a third bin 2 context is selected in the case that the current transform coefficient is preceded by two previously coded transform coefficients in the vector along the scan order having a value of 2,
wherein a fourth bin 2 context is selected in the case that the current transform coefficient is preceded by three or more previously coded transform coefficients in the vector along the scan order having a value of 2, and
wherein a fifth bin 2 context is selected in the case that the current transform coefficient is preceded by any previously coded transform coefficient in the vector along the scan order having a value greater than 2.

17. The apparatus of claim 11, wherein means for selecting a bin 2 context includes means for selecting a bin 2 context from a context model containing four bin 2 contexts.

18. The apparatus of claim 17,
wherein a first bin 2 context is selected in the case that the current transform coefficient is a first transform coefficient in the vector along the scan order having a value of 2,
wherein a second bin 2 context is selected in the case that the current transform coefficient is preceded by one previously coded transform coefficient in the vector along the scan order having a value of 2,
wherein a third bin 2 context is selected in the case that the current transform coefficient is preceded by two or more previously coded transform coefficients in the vector along the scan order having a value of 2, and
wherein a fourth bin 2 context is selected in the case that the current transform coefficient is preceded by any previously coded transform coefficient in the vector along the scan order having a value greater than 2.

19. An apparatus for coding transform coefficients in a video coding process comprising:
a video coder configured to:
select a bin 2 context for coding a bin 2 level of one or more transform coefficients in the vector according to the entropy coding process; and
code the bin 2 level of one or more transform coefficients in the vector according to the selected bin 2 context,
wherein selecting the bin 2 context comprises selecting the bin 2 context for a current transform coefficient in the vector based on the bin 2 level of one or more previously coded transform coefficients in a transform unit.

20. The apparatus of claim 19, wherein the video coder is further configured to scan at least a portion of a block of transform coefficients into a vector according to a scan order and wherein the selecting the bin 2 context comprises selecting the bin 2 context for a current transform coefficient in the vector based on the bin 2 level of one or more previously coded transform coefficients in the vector.

21. The apparatus of claim 19, wherein the entropy coding process is a CABAC process.

22. The apparatus of claim 19, wherein the video coder is further configured to select a bin 2 context from a context model containing five bin 2 contexts.

23. The apparatus of claim 19, wherein the video coder is further configured to:
select a first bin 2 context in the case that the current transform coefficient is a first transform coefficient in the vector along the scan order having a value of 2,
select a second bin 2 context in the case that the current transform coefficient is preceded by one previously coded transform coefficient in the vector along the scan order having a value of 2.

24. The apparatus of claim 23, wherein the video coder is further configured to:
select a third bin 2 context in the case that the current transform coefficient is preceded by two previously coded transform coefficients in the vector along the scan order having a value of 2,
select a fourth bin 2 context in the case that the current transform coefficient is preceded by three or more previously coded transform coefficients in the vector along the scan order having a value of 2, and
select a fifth bin 2 context in the case that the current transform coefficient is preceded by any previously coded transform coefficient in the vector along the scan order having a value greater than 2.

25. The apparatus of claim 19, wherein the video coder is further configured to select a bin 2 context includes selecting a bin 2 context from a context model containing four bin 2 contexts.

26. The apparatus of claim 25, wherein the video coder is further configured to:
select a first bin 2 context in the case that the current transform coefficient is a first transform coefficient in the vector along the scan order having a value of 2,
select a second bin 2 context in the case that the current transform coefficient is preceded by one previously coded transform coefficient in the vector along the scan order having a value of 2,
select a third bin 2 context in the case that the current transform coefficient is preceded by two or more previously coded transform coefficients in the vector along the scan order having a value of 2, and
select a fourth bin 2 context in the case that the current transform coefficient is preceded by any previously coded transform coefficient in the vector along the scan order having a value greater than 2.

27. The apparatus of claim 19, wherein the video coder is a video encoder.

28. The apparatus of claim 19, wherein the video coder is a video decoder.

29. The apparatus of claim 19, wherein the video coder is implemented in a processor.

30. The apparatus of claim 29, wherein the processor is in a mobile device.

31. A computer-readable storage medium having stored thereon instructions that, when executed by a processor, cause the processor to:
select a bin 2 context for coding a bin 2 level of one or more transform coefficients in the vector according to the entropy coding process; and
code the bin 2 level of one or more transform coefficients in the vector according to the selected bin 2 context,
wherein selecting the bin 2 context comprises selecting the bin 2 context for a current transform coefficient in the vector based on the bin 2 level of one or more previously coded transform coefficients in a transform unit.

32. The computer-readable storage medium of claim 31, further comprising instructions for causing a processor to:
scan at least a portion of a block of transform coefficients into a vector according to a scan order.

33. The computer-readable storage medium of claim 31, further comprising instructions for causing a processor to:
transform coefficient in the vector according to an entropy coding process; and
code the bin 1 level of one or more transform coefficients in the vector according to the selected bin 1 context.

34. The computer-readable storage medium of claim 31, further comprising instructions for causing a processor to:
implement the entropy coding process as a CABAC process.

35. The computer-readable medium of claim 31, further comprising instructions for causing a processor to:
select the bin 1 context comprises selecting the bin 1 context for a current transform coefficient in the vector based on the bin 1 level of one or more previously coded transform coefficients in the vector.

36. The computer-readable storage medium of claim 31, further comprising instructions for causing a processor to:
select a bin 2 context includes selecting a bin 2 context from a context model containing five bin 2 contexts.

37. The computer-readable storage medium of claim 31, further comprising instructions for causing a processor to:
select a first bin 2 context in the case that the current transform coefficient is a first transform coefficient in the vector along the scan order having a value of 2;
select a second bin 2 context in the case that the current transform coefficient is preceded by one previously coded transform coefficient in the vector along the scan order having a value of 2;
select a third bin 2 context in the case that the current transform coefficient is preceded by two previously coded transform coefficients in the vector along the scan order having a value of 2;
select a fourth bin 2 context in the case that the current transform coefficient is preceded by three or more previously coded transform coefficients in the vector along the scan order having a value of 2; and
wherein a fifth bin 2 context is selected in the case that the current transform coefficient is preceded by any previously coded transform coefficient in the vector along the scan order having a value greater than 2.

38. The computer-readable storage medium of claim 31, further comprising instructions for causing a processor to:
select a bin 2 context includes selecting a bin 2 context from a context model containing four bin 2 contexts.

39. The computer-readable storage medium of claim 31, further comprising instructions for causing a processor to:
select a first bin 2 context in the case that the current transform coefficient is a first transform coefficient in the vector along the scan order having a value of 2;
select a second bin 2 context in the case that the current transform coefficient is preceded by one previously coded transform coefficient in the vector along the scan order having a value of 2;
select a third bin 2 context in the case that the current transform coefficient is preceded by two or more previously coded transform coefficients in the vector along the scan order having a value of 2, and
wherein a fourth bin 2 context is selected in the case that the current transform coefficient is preceded by any previously coded transform coefficient in the vector along the scan order having a value greater than 2.

40. The computer-readable storage medium of claim 31, further comprising instructions for causing a processor to:
implement the video coding process as a video encoding process.

41. The computer-readable storage medium of claim 31, further comprising instructions for causing a processor to:
implement the video coding process as a video decoding process.
